(19) United States
(12) Patent Application Publication
(10) Pub. No.: US 2014/0279672 A1
(43) Pub. Date: Sep. 18, 2014

(54) Tools for Collecting and Managing Services-Related Information

(71) Applicant: Public Partnerships LLC, Boston, MA (US)

(72) Inventor: Jack Yung-Kung Liu, Westford, MA (US)

(21) Appl. No.: 13/844,230

(22) Filed: Mar. 15, 2013

(51) Int. Cl. G06Q 10/10

(52) U.S. Cl. CPC G06Q 10/10
USPC 705/345

(57) ABSTRACT

Apparatus may be provided that include at least one processor and memory, plural submission interfaces, a submission data structure, a submission processor, a feedback processor, and a set of payroll acceptance rules. The plural submission interfaces are configured to receive, from a worker, work information submissions, where one of the submission interfaces is configured to receive work information submissions from an application on a mobile device, and where another of the submission interfaces is configured to receive work information submissions from a web page. The submission data structure is configured to receive submission data output from the plural submission interfaces. The submission processor is configured to cause the data in the submission data structure to be processed, e.g., so that the worker is paid for work performed. The feedback processor is configured to perform one or more checks on the submission data in accordance with acceptance rules, in order to determine whether the submission data will be included in processing, the feedback processor being further configured to communicate the inclusion determination to the worker using a flexible communication method.

### FIELD OF THE DISCLOSURE

Aspects of the present disclosure relate to tools for communicating among various parties. Other aspects relate to tools for collecting and communicating services-related information (e.g., time and attendance information).

### BACKGROUND

Financial management services firms provide services to public agencies including acting as an employer agent for the agency. They help state, county, and local public agencies implement a participant-directed service model, also known as a consumer-directed or self-directed service model.

This model promotes independence by helping “participants” decide what they need. For example, the National Resource Center for Participant-Directed Services (www.bc.edu/content/bc/schools/gssw/nrcpds/whoweare/successstories.html) describes an experience of Josie Dickey, an 87 year old woman in Fort Smith, Ark., who benefited from a self-directed services program in Arkansas called the Cash and Counseling Program. In 2002, Josie suffered a massive stroke, at which point Josie went to live in a nursing home. Neglected there, she contracted pneumonia. Josie's daughter Brenda then brought her home to live with her, relying on a number of different traditional health aides to provide care, 30 different aides in 3 years. Upon learning about the Cash and Counseling Program, Brenda quit her regular job in order to work as her mother's caregiver—compensated by the state under the program. Josie has since been healthier, growing stronger because of her daughter's consistent presence in her care.

This presents the public agency offering the program or service with a challenge. The increase in service flexibility—allowing a participant like Josie to direct her care and choose her daughter as the caregiver—makes it harder to comply with financial accountability requirements, e.g., of the Centers for Medicare & Medicaid Services (CMS) and the Internal Revenue Service (IRS). These programs may also provide a greater risk of fraud and abuse.

Accurate time and attendance collection and management are particularly challenging in this context. Some caregivers may not have landline access to the Internet, or a mobile phone with a data plan. These caregivers need to be able to submit time and attendance information via fax, a scanner, or even mail.

### SUMMARY

One objective of the present disclosure may be to give a service provider (e.g., an individual worker) flexibility in how he or she submits work information, for example, time and attendance information, for processing (e.g., for payment). Another objective may be to provide new tools that allow an administrative organization to more effectively manage the collection and processing of this work information, so that the service provider (e.g., a worker) is paid faster without errors (e.g., without payroll errors if the work information is used to process payroll).

One or more alternate or additional objectives may be served by the present disclosure, e.g., as may be apparent by the following description. Embodiments of the disclosure include any apparatus, machine, system, method, articles (e.g., non-transient computer-readable media), or any one or more subparts or subcombinations of such apparatus (singular or plural), system, method, or article, e.g., as supported by the present disclosure. Embodiments herein also contemplate that any one or more processes as described herein may be incorporated into a processing circuit.

In accordance with one embodiment of the present disclosure, apparatus may be provided that include at least one processor and memory, plural submission interfaces, a submission data structure, a submission processor, a feedback processor, and a set of acceptance rules. The plural submission interfaces are configured to receive, from a worker, work information submissions, where one of the submission interfaces is configured to receive work information submissions from an application on a mobile device, and where another of the submission interfaces is configured to receive work information submissions from a web page (e.g., a web portal). The submission data structure is configured to receive submission data output from the plural submission interfaces. The submission processor is configured to cause data in the submission data structure to be processed. The feedback processor is configured to perform one or more checks on the submission data in accordance with the acceptance rules, in order to determine whether the submission data is submission ready and therefore will be included for subsequent processing. The feedback processor is further configured to communicate the submission ready determination to the employee using a flexible communication method.

### BRIEF DESCRIPTION OF THE DRAWINGS

Example embodiments will be described with reference to the following drawing figures in which:

FIG. 1 is a schematic diagram of a participant-directed work information submission system;

FIG. 2 is a schematic diagram of select elements of a communication device;

FIG. 3 is a flow diagram depicting processes and dialogue among various portions of the participant-directed work information submission system depicted in FIG. 1;

FIG. 4 is a flow chart showing operation of a work information submission smartphone app;

FIG. 5 is a schematic diagram of an interface for prompting for and for receiving as input certain employee preferences;

FIG. 6 is a screen shot of a login interface in a smartphone app;

FIG. 7 is a screen shot of a home page interface;

FIG. 8 is a screen shot of a clock-in initiation interface;

FIG. 9 is a screen shot of a clock-in data summary interface;

FIG. 10 is a screen shot of a clock-out summary and approval interface;

FIG. 11 is a screen shot of a submission confirmation interface;

FIG. 12 is a screen shot of a submission confirmation interface with a menu sub-interface activated;

FIG. 13 is a screen shot of a QR input interface;

FIG. 14 is a screen shot of an SMS option interface; and

FIG. 15 is a screen shot of a history detail with an activated scrollable area.

### DETAILED DESCRIPTION

In accordance with one or more embodiments herein, various terms may be defined as follows.

Administering entity. An entity that administers a given program, e.g., a work program such as a self-directed service model.

Application program interface (API); and API interface. An API may be an operational interface of an application, by which the application can be invoked, and to or from which parameters can be passed. An API interface may include an API call that has both a path or channel for getting to a given API and a data-interchange format for passing one or more parameters to or from the API. An example HTTP-based API call a given mobile device might use to call upon an API at a remote system (e.g., accessible via the Internet when the mobile device is connected to the Internet) may be in the form of <URL><function>.<specified format><parameters in specified format>.

Application program. An application program is a program that, when executed, involves user interaction, whereas an operating system program, when executed, serves as an interface between an application program and underlying hardware of a computer.

Claim. A submission for an episode of service, where the submission describes the service that was provided.

Communication device. A communication device is a communications processing circuit with computing, human interface, and display abilities. A communication device may be, for example, a cell phone or a browser on a device having network access. A communication device may be configured so that only an authorized user can access the communication device. This limited access to the communication device may be controlled with a user credentials authentication engine accessible by the user via a human interface including one or more displayed authentication graphical input and/or output tools on the communication device.

Data interface. A data interface is a physical signal carrying device and/or a data structure, and includes a standard data format known by (or implicitly abided by) each of a plurality of interfaced devices either taking data from another interfaced device or providing data to another interfaced device.

Data structure. A data structure is a way of storing and associating data on non-transient computer-readable media. A data structure may include a linked data structure that has data records (nodes) linked together by references (links or pointers). A data structure may also (or instead) include another type of data structure that requires one or more arithmetic operations on one or more pointers. An example of a linked data structure may be where a piece of data (node A) is associated with another piece of data (node B) by providing node A with a pointer that points to the location of node B. Media-stored data structures herein are non-transient computer-readable media (or portions thereof) encoded with linked or other data structures.

Interface. An interface includes hardware and/or one or more media-stored data structures interoperating with a machine (or both hardware and media-stored data structure(s)), configured to provide a connection. The connection is between at least two processing circuits to allow data or signals to be shared or transferred (or exchanged) among the processing circuits.

Participant. A person or entity being cared for, i.e., for whom the service is being provided by the service provider or by a worker.

Processing circuit (or process mechanism). A processing circuit may include both (at least a portion of) non-transient computer-readable media carrying functional encoded data and components of an active computer. The active computer is ready to execute (or is already executing) the functional encoded data, and thereby causes certain acts to occur. A processing circuit may also include: a machine or part of a machine that is specially configured to carry out a process, e.g., any process described herein; or a special purpose computer or a part of a special purpose computer. A processing circuit may also be in the form of a general purpose computer running a compiled, interpretable, or compilable program (or part of such a program) that is combined with hardware carrying out a process or a set of processes. A processing circuit may further be implemented in the form of an application specific integrated circuit (ASIC), part of an ASIC, or a group of ASICs. A processing circuit may further include an electronic circuit or part of an electronic circuit. Neither a processing circuit nor a process mechanism exists in the form of code per se, software per se, instructions per se, mental thoughts alone, or processes that are carried out manually by a person without any involvement of a machine.

Program. A program includes software of a computer process mechanism or a processing circuit.

Remittance advice. Information regarding a status of a given submitted claim.

Service provider. An entity (a legal entity, a group, or an individual) that provides a service, e.g., directly, by contracting, or employing one or more workers.

User interface tools; User interface elements; output user interface; input user interface; input/output user interface; and graphical user interface tools. User interface tools are human user interface elements which allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools). Graphical user interface tools (graphical tools) include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touch screen sensor, with keys of a keypad, a keyboard, etc., and/or with a screen pointer element controllable with a mouse, toggle, or wheel), visually communicate to a user data to be input and to visually and interactively communicate to the user the device's receipt of the input data. A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen displayed icons, buttons, forms, or fields. When user interface elements are presented herein, for example, schematically in a drawing, a corresponding media-stored data structure may exist or be created with which the user interface elements are interfaced.

Web portal. A web browser accessible website that brings information together from different sources. A portlet is an area on such a website for a subset of that information (e.g., from one or a few of the different sources)

Worker. One who provides a service to a participant. Examples of workers include an attendant, a personal assistant, and a direct support worker. A worker may be, e.g., a contract worker or an employee.

Work information. Information documenting work performed, e.g., required in order for the worker to receive payment. Work information may be or include time and attendance information.

Referring now the drawings in greater detail, FIG. 1 shows a work information submission system 10 per one embodiment of the present disclosure. The illustrated system 10 is deployed in the context of a participant-directed service model. As shown, a participant 26 is situated at a locale, e.g., at his or her home, and has hired a service provider, e.g., a worker 28 to provide assistance. For example, an adult or child participant with developmental disabilities may require at home assistance with day-to-day activities.

Worker 28 and participant 26 are able to form this relationship under a program of a program owner, e.g., a public agency 24, administered by an administering entity, e.g., a financial management services firm acting as an employer agent 22. On a personal level, the agent 22 may assign a care manager 30 to setup, monitor, and otherwise manage the relationships involved. While agent 22 is identified as an employer agent in this example, any contractor or other relationship may be involved, in which case the agent 22 could be, e.g., a contractor agent or third party administrator.

Information technology tools may be used to facilitate communications among participant 26, worker 28, agent 22, and agency 24. For example, as shown in FIG. 1, worker 28 may have access to one or more worker communication devices 32, while agent 22 has one or more employer agent communication devices 34, and agency 24 has one more agency communication devices 36.

These systems 32, 34, 36 are used, among other things, to allow a worker 28 to send work information submissions (time and attendance information) to employer agent 22 for processing. In the illustrated embodiment, the processing leads to or is a precursor to the worker ultimately receiving payment for rendered services. Worker communication devices 32 may include, e.g., a mobile device, a laptop computer, a tablet, a mobile phone, a smartphone, a GPS, and/or a QR scanner. The GPS component may be part of, e.g., a smartphone, and can be used to corroborate the worker's location at the time of clock-in and clock-out. A QR scanner may also serve to corroborate the worker's location. A unique QR code in the possession of participant 26 or at the participant locale 20 may be scanned using a smartphone, when reporting time and attendance information, and by scanning that QR code, the worker corroborates his or her location.

In accordance with another embodiment, a travel or location calculator may be provided, e.g., as part of an app on a worker communication device 32 or as part of submission processor 62, whereby the location (ascertained with the aid of GPS, triangulation, communication timing, NFC or other data) of a worker's communication device and/or the timing of clock-in/clock-out and other inputs are monitored to calculate, validate or check, e.g., whether mileage reimbursement claims are accurate, or whether worker 28 performed a given task requiring travel from one location to another.

As shown in FIG. 2, the illustrated communication devices 32, 34, and 36 each include certain processing circuitry. In the embodiment shown, that processing circuitry includes hardware elements 100 and code elements 102. The illustrated hardware elements 100 include a memory hierarchy subsystem 104, a bus 106, and processor(s)/ASIC(s)/other hardware 108. As shown in FIG. 2, the other hardware may include a display 110, other user interface elements 112, and network interface circuitry 114. By way of example, display 110 may include an LCD or other type of computer display or device display. Other user interface elements 112 may include, for example, a keypad, soft keys, touch screen elements, and pointing devices such as roller balls, rotatable discs, and the like. Meanwhile, network interface 114 may include network interface hardware and driver software encoded on non-transient computer-readable media and configured to interact with the interface hardware to cause, for example, wire or wireless protocol communications with a network. Network interface 114 may include other types of wireless or wired network interconnection and protocol features. Code elements 102 include other code aspects of the select processing circuitry shown in FIG. 2, including data, data structures, and programming code.

The illustrated employer agent devices 34 may be as shown in greater detail in the bottom portion of FIG. 1. Namely, a plurality of submission interfaces 38 may be provided, which are configured to receive, from employee 28, work information submissions. Those submission interfaces 38 comprise a mobile application program API and associated processes 40, an IVR interface and associated processes 42, an image form interface and associated processes 44, and a web portal and associated processes 46.

Employer agent communication system 34 further comprises a submission data structure 60 and a submission processor 62. Submission data structure 60 is configured to receive submission data output from the plural submission interfaces. The submission data for a given submission by a worker 28 may, per one embodiment, include data associated with both a clock-in and a clock-out, whereby the data fully represents a block of time worked, attendance at a given locale, and certain corroborating and verifying information. As shown in FIG. 1, this clock-in and clock-out data includes the following data for a which the submission data structure has corresponding fields: a submission ID 70 uniquely identifying the submission; a worker ID 72 uniquely identifying the worker (e.g., an employee number or the worker's social security number); a participant ID 74 uniquely identifying the participant; a date of service 76; a start time 78 being the time the worker started working for the block of time associated with the submission (the clock-in time for the illustrated embodiment); an end time 80 when the worker finished the current block of work time; a location 82

Each of submission interfaces 38 is configured to communicate with an individual regarding the submission of work information, e.g., to verify that a worker is performing his or her duties and to gather the information necessary to process payroll. Each of these submission interfaces in the illustrated embodiment accommodates a particular communication channel or group of communication channels (e.g., as shown, via a mobile app (interface 40), a web portal (interface 46), an interactive voice response (IVR) telephone call (interface 42), or mail, fax, or email (interface 44)). In the illustrated embodiment each submission interface is configured to receive information from a worker or participant and relay that information to a submission processor 62, and is configured to send information from the submission processor 62 to a worker or participant.

Mobile app API 40 is provided with a processing circuit. The processing circuit of mobile app API 40 includes, among other components, an interface for communicating with an SMS interface 48 and an operational interface to an application that can be invoked or to which parameters can be passed by or from a mobile device, such as, for example, a mobile phone, a smart phone, a tablet, a laptop computer, etc. In the illustrated embodiment, mobile app API 40 is accessible by such a mobile device via an internet protocol connection. IVR interface 42 has a processing circuit for processing interactive voice response functionality, allowing for calls to be placed to a given individual via his or her telephone number, and allowing for calls to be received by an individual placed via a telephone call. IVR interface 42 may include, for example, voice recognition circuitry, recorded utterances or voice generation circuitry, and logic for allowing certain messages to be communicated to a given user through a telephone call, and allowing utterances communicated to the interface 42 in the form of voice to be captured, stored, and interpreted.

Image form interface 44 may include an interface for accepting manual data entry whereby a person may obtain certain data from an image or document, and inputs that data into a computer via a direct computer user interface. In addition, or alternatively, image form interface 44 may interface with a fax server and/or image repository 50, and with a mail processing input 52. Image form interface 44 may be provided with one or more automated processing subsystems, in the form of processing circuits. Forms may be automatically processed by, for example, first identifying a batch of completed forms that have been scanned (for example, that are on the fax server portion of fax server/image repository 50 or that are stored in the image repository portion thereof. The images may then be cleaned with document image processing algorithms in order to improve the accuracy with which data can be gleaned from the forms. The forms are then classified, for example, using a template, and the desired field may be extracted using optical character recognition and recognizing the location of certain data based upon where it exists within the image.

Web portal interface 46 may be provided with html or other web page code for providing certain information on one or more web pages and which may be accessed through the use of a web browser.

Each of interfaces 40, 42, 44 and 46 is provided with one or more processing circuits that facilitates the provision of various types of user interface tools to a given worker 28, via his or her worker communication device 32. A user interface tool may, for example, be a user interface element, an output user interface, an input user interface, an input/output user interface, and/or a graphical user interface tool. For one example, a graphical user interface tool may be presented to worker 28 via his or her worker communication device 32 by presenting such a tool on a screen of that device through the use of mobile app API 40. In addition, or alternatively, information may be communicated to worker 28 via a screen on worker communication device 32 via an SMS communication, utilizing SMS interface 48. In addition, a prompt for input by worker 28 may be displayed on a worker communication device 32 by a processing circuit within mobile app API 40.

SMS interface 48 is configured to receive SMS messages from a worker communication device 32, and to send SMS messages to a worker communication device 32.

Fax server and/or image repository 50 includes a subsystem with processing circuits for receiving and storing faxes and other digital images in a fax server or repository form. Mail processing input 52 may include an automated processing input for processing physical mail, for example, received using the U.S. Postal Service. In addition, mail processing input 52 may include a computer data terminal with human user input mechanisms for manual data entry of information provided on physical mail that is received.

Submission processor 62, as illustrated in the embodiment, includes a feedback processor 64, a rule engine 66, and one or more databases 68. Feedback processor 64 is provided with an output for communicating information back to a given worker 28 via one or more of submission interfaces 38. Rule engine 66 includes rules for performing one or more checks on submission data 60 in accordance with, for example, submission acceptance rules. In the illustrated embodiment, the data must have a certain format and meet certain requirements in order to be conditionally accepted for further processing to allow the worker 28 to be paid. That process may involve payroll processing. Rule engine 66 generally includes acceptance rules which are used to determine whether the submission data is submission ready and, therefore, be included in subsequent processing, where that processing may be payroll processing.

Feedback processor 64 is further configured to communicate a submission ready determination to a worker 28 via worker communication device 32 using a flexible communication method. For example, the submission ready determination may be communicated by stating at least one of: that the submission was successful, that specific information is still needed, and that specific information contained in the submission requires correction. The flexible communication method may involve a situation where the submission data 60 is originally obtained by a worker 28 through one submission interface among submission interfaces 38 while feedback in the form of a communication of the submission ready determination is communicated back to worker 28 via a different submission interface among submission interfaces 38. This method by which the worker 28 is communicated the feedback may be chosen by worker 28 independently from how worker 28 submits the work information submission. This choice of the flexible communication method by which the feedback is provided to worker 28 may be chosen by worker 28 at the time the worker submits the work information submission. In other words, if worker 28 is communicating via a submission interface 38 (for example, mobile app API 40) using his or her mobile phone or smartphone, during that process of submitting that work information submission, one of the types of information worker 28 may provide may include the method by which feedback will be provided to worker 28, which may involve a different submission interface. The different submission interface for feedback may include, for example, a voice telephone call using IVR interface 42.

The flexible communication method may also be a method chosen by the employee in advance of any work information submissions, for example, during a set up process. In accordance with another embodiment, the flexible communication method is determined in accordance with an escalation process starting with one communication method, and sequentially trying one or more communication methods, until an indication is received confirming receipt by the employee of the information. Per one example embodiment, the starting communication method for communicating feedback may be the same channel (for example, using a mobile app API submission interface 40, feedback being relayed back through the same mobile app API submission interface 40). A next communication method that may be attempted, if confirmation is not obtained that worker 28 received the feedback, could be an email to the worker. A next communication channel in the escalation process might include an SMS text message to a particular mobile phone number of worker 28. A next communication channel in the escalation process might include sending a fax to a particular designated fax number of worker 28, and/or a voice telephone call made using IVR interface 42.

FIG. 3 provides a flow diagram depicting processes and dialogue among various portions of the system depicting in FIG. 1, namely worker communication device 32, submission interface or interfaces 38, submission processor 62, feedback processor 64, rule engine 66, and databases 68.

The processes depicted in FIG. 3 may involve one or more of the submission interfaces per the description above and as shown in FIG. 1. Accordingly, the various communications depicted in FIG. 3 are generic, but will generally vary depending upon the type of submission interface and worker communication device deployed in the given instance.

In an initial communication, worker communication device 32 communicates with submission interface 38 in order to perform a worker setup at 200. Then, in act 202, setup data is sent from submission interface 38 to submission processor 62. That setup data, in act 204, is communicated from submission processor 62 to database 68. Upon this happening, in act 206, a confirmation is sent from submission processor 62 to submission interface 38, and in the next act 208, a confirmation is sent from submission interface 38 to worker communication device 32. At a certain point in time, a worker at a given locale will initiate a clock-in. When this happens, at act 210, an initiate clock-in communication is sent from worker communication device 32 to submission interface 38. Then, in act 212, certain corroborating data may be sent from worker communication device 32 to submission interface 38. For example, corroboration data may include a QR code whereby a unique QR code can be scanned at a given locale for a participant, or near field communication (NFC) data obtained at a given locale. In addition, or alternatively, corroboration data may include a date and time stamp generated by worker communication device 32 independently of any data input by the individual controlling that communication device. Caller ID information may be used to corroborate certain data provided by the worker. In addition, mobile cell triangulation data may be used to confirm the locale of the worker.

All this data will ultimately form part of the submission data that is ultimately sent to databases 68.

In the next act, 214, submission interface 38 prompts worker communication device 32 for certain data whereby a worker provides the data by using his or her worker communication device. That data forms the rest of submission data that is at that point sent in act 216 from worker communication device 32 to submission interface 38. At this point, i.e., act 218, the submission data and a data check request are each sent to submission processor 62. Thereafter, in act 220, submission processor 62 sends a data check communication to feedback processor 64. At this point, i.e., acts 222 and 224, feedback processor 64 communicates with rule engine 66, and rule engine 66 communicates with databases 68. Feedback processor 64 obtains certain access rules from rule engine 66 and rule engine 66 obtains certain rule data from databases 68. Once this is complete, and feedback processor 64 has processed the appropriate rules and rule data, feedback processor 64 is ready in act 226 to communicate feedback from feedback processor 64 to submission interface 38, which is forwarded in act 228 to worker communication device 32.

When a worker is done with providing services during a given day, in act 230, the worker may use his or her worker communication device 32 to initiate a clock-out process. Then, in act 232 corroborating data may be provided to corroborate the current submission. Thereafter, in act 234, submission interface 38 may prompt worker communication device 32 for data. Then, in act 236, submission data is provided from worker communication device 32 to submission interface 38. In act 238, data and a data check request are communicated from submission interface 38 to submission processor 62. At that point, in act 240, submission processor 62 sends a data check request to feedback processor 64. At this point, in acts 242 and 244, feedback processor accesses rules by interfacing with rule engine 66, and rule engine 66 accesses rule data by interfacing databases with databases 68. Feedback processor 64 determines the feedback and communicates that feedback in act 246 to submission interface 38, which is then relayed back to worker communication device 32 in act 248. Meanwhile, in acts 227 and 250, while feedback is provided, submission data from the worker is forwarded from submission processor 62 to database 68.

In a subsequent act for the clock-out procedure, i.e. act 252, certain verification, authentication, and other data may be provided from worker communication device 32 to submission interface 38. This data may include information provided by the consumer. For example, the consumer may verify certain information regarding the submission, such as the time, the types of services provided, etc. In addition, the consumer may provide unique authentication information authenticating the fact that it is indeed the consumer interfacing with worker communication device 32 and providing that information. Other pertinent data that would be helpful from the consumer may be provided at this point in time.

In act 254, this data and a data check request are provided from by submission interface 38 to submission processor 62. A data check request is then forwarded at act 256 to feedback processor 64. At this point, in acts 258 and 260, feedback processor communicates with rule engine 66 to access rules and rule engine 66 communicates with databases 68 in order to access rule data.

In acts 262 and 264, a submission ready determination is communicated from feedback processor 64 back to a worker communication device by via submission interface 38. The illustrated system may be configured so that a worker confirms receipt of this feedback in a subsequent act 266.

Submission processor 62 may in one embodiment be provided with a configurable rule override feature that allows an operator interfacing with submission processor 62 to change a given rule in the rule engine or to override a rule. In addition, while feedback may communicate errors or requests for different or additional information, a feedback communication may be configured per several modes. One mode may include a silent mode, where the submission is accepted without feedback and despite errors, and another mode may include a verbose mode where all feedback is communicated, and where the submission may be either rejected or (per one embodiment) the worker is presented with an option to submit regardless of the errors.

Rule data may include, for example, as shown in the right hand portion of FIG. 3, certain caller ID rules such as whether or not the call came from a preauthorization phone number or another rule could be whether the caller ID indicates that the call is coming from a non-approved geographic area. Another rule could be that the consumer is indeed matched with that worker, that the identification of the worker or consumer is correct, and that the amount of services and the occurrence of the services are consistent with certain budget limitations. Other rules may be provided as well.

FIG. 4 provides a flow chart of an operation of a work information submission application that may be provided on a given mobile device, for example, a mobile phone or a smart phone. In act 402, a QR code may be scanned using a data communications device, where that QR code indicates that the person operating that mobile device is at a particular location. For example, the QR code is only accessible to that location and is associated with that location. While this is performed at act 402, this could be performed at a later time in the process.

In the next act 404, the service information is input, as part of the clock-in process. At this point, in act 406, a determination is made as to whether or not the mobile device is connected to the network, such that an internet connection is available to allow access to the mobile app API 40. If there is no data service, in act 408, the user on the mobile device may be prompted to save the information where that information will be sent at a later time, or to choose an option by which the information is sent via SMS texts. If this occurs, an SMS interface provided on the mobile device is used to transmit SMS messages from the mobile device to mobile app API 40 via an SMS interface 48, as shown in FIG. 1.

If the determination at act 406 indicates that there is a data service, at act 410, the information is transmitted using the network, generally, an IP network. The service information is reviewed, including the clock-in time and service receiver information. Then, in act 414, a given worker may select a clock-out process once his or her service is completed for a given day. In act 416, a participant approval passcode may be entered by a participant using the same mobile device that was used in previous steps. Per acts 415 and 417, a network connection may be unavailable in which case a save versus SMS option will again be presented.

While this embodiment provides SMS texts as a channel for communicating when the data service is unavailable or limited in some way, per another embodiment, there may be (depending upon the device and the connector service) another alternative communication channel that could be employed. In addition, instead of SMS, a variation such as MMS or another protocol may be available.

After act 416, in act 418, the submission information is transmitted and reviewed, and feedback is provided.

FIG. 5 provides a schematic diagram of an interface 500 for prompting and for receiving employee preferences. These preferences may be provided during an early setup, which is before any submission, for example, a clock-in or clock-out. Alternatively, this employee preference interface, for example, as shown in FIG. 5, may be presented to a given worker during the submission of information in a clock-in process or a clock-out process. The illustrated interface 500 includes an interface tool 502 for providing employee information, an interface tool 504 for providing contact information, an interface tool 506 for providing frequency of contact information, and an interface tool 508 for providing additional options. Each of the illustrated interface tools shown in FIG. 5 may be user interface elements, output user interfaces, input user interfaces, input/output user interfaces, and/or graphical user interface tools.

In accordance with the embodiment, employment information interface tool 502 may allow a worker, in this example an employee, to provide information about himself or herself, including telephone number, mobile phone number, address, age, etc. Contact information user interface tool 504 may be provided with a plurality of contact method user interface tools 505a, 505b through 505N. Each of these contact methods identifies a triggered communication channel and a particular contact method for reaching that channel. For example, a contact method may include a voice phone call selection as well as provide a particular phone number which may be used to reach the worker via a voice phone call. A given contact method 505 may include a selection of fax or email as a contact method, and then provide a particular fax number or email address. A plurality of voice phone numbers for voice calls and a plurality of fax or email contacts may be provided. These alternate contact methods and addresses for those contact methods may form part of the types of contact methods that are used in the escalation procedure when submission ready determination is communicated back to a given worker. Other types of contact methods may include contact via a mobile app or via a web page. User interface tool 505 may also include user interface elements, output user interfaces, input user interfaces, input/output user interfaces, and/or graphical user interface tools.

User interface tool 506 includes a plurality of contact method frequency user interface tools 507a, 507b through 507N. Each of these user interface tools may also be a user interface element, output user interface, input user interface, input/output user interface, and/or graphical user interface tools. In the illustration embodiment, each of these frequency indicators includes an input for selecting the frequency with which a given contact method selected in the contact information user interface tool 504 is used to communicate information to a particular worker. This information may include various types of rules regarding how frequently information is communicated to the worker.

FIG. 6 is a screen shot of a login on a smart phone app. As shown in FIG. 6, during a login procedure, a worker's user identification and password may be provided. A log in button 600 is provided for submitting the log in information. The login information includes a user ID to be input to a user ID field 602, and a password that is input to a password field 604. Each of the elements shown in the screen shots in FIGS. 6-15, generally is a graphical user interface tool. Many of the elements include input/output user interface elements.

FIG. 7 shows a home page screen shot, which includes a display of the total number of visits 700, the total number of hours worked by a given worker 702, and information regarding the last visit in a display portion 704. In addition, a button allowing for the start of a new client 706 may be provided, by which a given worker may start inputting information regarding a new client, for example, a new participant. Another user interface tool 708 may be provided for giving the worker access to new or updated features. FIG. 7 also includes a menu activation button 710.

FIG. 8 provides a screen shot with a clock-in initiation. The illustrated screen shot includes a map 800 identifying where the worker is, and a textually displayed, address 802 indicating the address at which the worker is currently located. This information may be provided by GPS functionality in the smart phone whereby the map and the location are automatically determined. User interface tools for identifying the service receiver 804 and for identifying the service code 806 are provided. A clock-in button 808 is provided, which can be activated by a worker in order to start the clock-in process.

FIG. 9 provides a screen shot which includes a clock-in data summary. The clock-in details shown include time information 900, service receiver information 902, service information 904, location information 906, an activity check list user interface tool 908, and a note option 910. Additional buttons include a finished with service button 912 and a clock-out button 914.

Each of the information elements 900, 902, 904, and 906 presents information back to the worker so the worker can know the submission data that is to be submitted. A checklist 908 may be provided which allows worker 28 to be provided with a particular list of activities to be done for a participant. This information could come from care manager 30 and/or participant 26, and may include information that is stored in databases 68. A worker, upon clocking-in, may access this checklist of particular activities to be performed and download the checklist by interacting with checklist user interface tool 908. If the worker 28 wants to add one or more notes, the worker can activate user interface tool 910. Upon finishing the service, the user can indicate that the service is finished by interfacing with button 912, and can initiate a clock-out procedure by interfacing with button 914.

FIG. 10 provides a screen shot of a clock-out summary along with a prompt for approval of the clock-out submission. Accordingly, this screen shot includes current time information 1002, clock-in time information 1004, and the current total time worked 1006. A message is displayed on the screen indicating the client needs to enter a passcode before the worker can clock out or before the clock out will be effective. Accordingly, an input field 1008 is provided for allowing an approval passcode to be entered into the device. A clock-out button 1010 is provided which can be activated in order to try to initiate the clock-out process. The clock-out button 1010 may either not function until an appropriate approval passcode is entered into field 1008, or clock-out button 1010 may be activated, but the submission may result in feedback indicating that the approval passcode was not the correct approval passcode, thereby halting the clock-out process.

FIG. 11 provides a screen shot with submission confirmation being communicated to the worker, along with a button for allowing a new client to be started.

FIG. 12 also includes the same information in FIG. 11, along with an activated menu.

FIG. 13 provides a screen shot with a QR code input graphically depicted.

FIG. 14 provides a screen shot identifying certain SMS options. The screen in this embodiment may be provided to the worker when there is no data service and therefore no internet connection for a given mobile device. In this embodiment, there are two options that may be used to send the information. With one option, the worker may save and send information once the internet has connectivity. This may occur by prompting the worker at a later time and asking the worker if they want the information to be sent, or the app on the mobile device may be configured so that the information is automatically sent once internet connectivity exists. With the other option, the submission information may be sent right away using SMS text messages. In order to choose one of these two options, a worker can activate a save and send later button 1400 or a send SMS button 1402.

FIG. 15 includes a history detail screen shot including a map 1502, in and out time and date information 1504, and an indication that the submission information has been successfully submitted at 1506. In a lower portion of the screenshot, other information is provided including service receiver information 1508, service code information 1510, location information 1512, and a checklist activation user interface tool 1514. The lower area may comprise, a scrollable area 1516. Examples of activities that be presented to the worker include, providing certain medication to the participant, shopping and obtaining groceries for the participant, picking up a wheelchair, and preparing dinner. Input/output elements may be provided in the form of check indicators whereby the worker can indicate that the task has been completed by providing a checklist. This information is then stored locally on the mobile device, and then forwarded to the appropriate storage location on databases 68 during an appropriate point in the process.

While the work information submission system 10 in the embodiment shown in FIG. 1 is deployed in a participant-directed service model, other applications may be deployed in other embodiments. For example, a health care provider (e.g., a hospital) or other service provider may use the illustrated information submission system for gathering, reporting, and keeping track of tasks, services, and/or claims (e.g., insurance claims). Accordingly, a given submission may be about a task or service, or about an insurance claim for a task or service.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
plural submission interfaces configured to receive, from a worker, work information submissions, where one of the submission interfaces is configured to receive work information submissions from an application on a mobile device, and where another of the submission interfaces is configured to receive work information submissions from a web page;
a submission data structure configured to receive submission data output from the plural submission interfaces;
a submission processor, a feedback processor, and a set of acceptance rules, the submission processor being configured to cause data in the submission data structure to be processed, the feedback processor being configured to perform one or more checks on the submission data in accordance with the acceptance rules, in order to determine whether the submission data is submission ready and thus will be included in processing, the feedback processor being further configured to communicate the submission ready determination to the employee using a flexible communication method.

2. The apparatus according to claim 1, where the submission data structure includes respective fields for holding a submission ID, a worker ID, a participant ID, a date of service, a start time, an end time, location information, location verification information, a service code, participant authentication information, and participant verification information.

3. The apparatus according to claim 1, wherein the submission processor includes a mechanism to include the submission data in payroll processing so that the worker is paid for work performed.

4. The apparatus according to claim 1, wherein the submission ready determination is communicated by stating at least one of: that the submission was successful, that specific information is still needed, and that specific information contained in the submission requires correction.

5. The apparatus according to claim 1, wherein the flexible communication method is a method chosen by a worker acting as the service provider, independently from how the worker submits the work information submission.

6. The apparatus according to claim 5, wherein the flexible communication method is a method chosen by the worker at the time of the work information submission.

7. The apparatus according to claim 5, wherein the flexible communication method is a method chosen by the worker in advance of the work information submission.

8. The apparatus according to claim 5, wherein the flexible communication method is determined in accordance with an escalation process starting with one communication method, and sequentially trying one or more communication methods, until an indication is received confirming receipt by the worker of the information.

9. The apparatus according to claim 5, wherein the flexible communication method is via a group of SMS text messages when the work submission was received via a group of SMS text messages.

10. Apparatus comprising:
a mobile device including at least one processor, a display, and memory;
a submission maker configured to cause work information submissions to be sent from a service provider using the mobile device to an administrative entity for processing;
a short message service (SMS) interface for transmitting SMS messages from the mobile device;
a submission delivery interface configured to determine if data service is active for the mobile device; and
an SMS option user interface tool configured to present to the service provider on the display an SMS option graphical input user interface that allows the service provider to choose that a submission is to be sent as a set of SMS messages for processing.

11. A method comprising:
via plural submission interfaces, receiving, from an service provider, work information submissions, where one of the submission interfaces is configured to receive work information submissions from an application on a mobile device, and where another of the submission interfaces is configured to receive work information submissions from a web page;
receiving into a submission data structure submission data output from the plural submission interfaces;
causing the data in the submission data structure to be processed;
performing one or more checks on the submission data in accordance with acceptance rules, in order to determine whether the submission data will be deemed submission ready and thus be included in processing; and
communicating the payroll inclusion determination to the employee using a flexible communication method.

12. The method according to claim 11, where the submission data structure includes respective fields for holding a submission ID, a worker ID, a participant ID, a date of service, a start time, an end time, location information, location verification information, a service code, participant authentication information, and participant verification information.

13. The method according to claim 11, further comprising including the submission data in payroll processing.

14. The method according to claim 11, wherein the submission ready determination is communicated by stating at least one of: that the submission was successful, that specific information is still needed, and that specific information contained in the submission requires correction.

15. The method according to claim 11, wherein the flexible communication method is a method chosen by a worker independently from how the worker submits the work information submission.

16. The method according to claim 15, wherein the flexible communication method is a method chosen by the worker at the time of the work information submission.

17. The method according to claim 15, wherein the flexible communication method is a method chosen by the worker in advance of the work information submission.

18. The method according to claim 15, wherein the flexible communication method is determined in accordance with an escalation process starting with one communication method, and sequentially trying one or more communication methods, until an indication is received confirming by the worker receipt of the information.

19. The method according to claim 15, wherein the flexible communication method is via a group of SMS text messages when the work submission was received via a group of SMS text messages.

20. A method comprising:
providing a mobile phone including at least one processor, a display, and memory;
causing work information submissions to be sent from a service provider using the mobile device to an administrative entity for processing;
transmitting SMS messages from the mobile device;
determining if data service is active for the mobile device; and
presenting to the service provider on the display an SMS option graphical input user interface that allows the service provider to choose that a submission is to be sent as a set of SMS messages for processing.

21. Non-transient computer-readable media, encoded to cause:
via plural submission interfaces, receiving, from a worker, work information submissions, where one of the submission interfaces is configured to receive work information submissions from an application on a mobile device, and where another of the submission interfaces is configured to receive work information submissions from a web page;
receiving into a submission data structure submission data output from the plural submission interfaces;
causing the data in the submission data structure to be processed;
performing one or more checks on the submission data in accordance with the acceptance rules, in order to determine whether the submission data is submission ready and thus will be included in processing; and
communicating the submission ready determination to the worker using a flexible communication method.

22. The non-transient computer-readable media according to claim 21, further encoded such that the submission data structure includes respective fields for holding a submission ID, a worker ID, a participant ID, a date of service, a start time, an end time, location information, location verification information, a service code, participant authentication information, and participant verification information.

23. The non-transient computer-readable media according to claim 21, further encoded such that the submission data is included in payroll processing.

24. The non-transient computer-readable media according to claim 21, further encoded such that the submission ready determination is communicated by stating at least one of: that the submission was successful, that specific information is still needed, and that specific information contained in the submission requires correction.

25. The non-transient computer-readable media according to claim 21, further encoded such that the flexible communication method is a method chosen by the worker independently from how the worker submits the work information submission.

26. The non-transient computer-readable media according to claim 25, further encoded such that the flexible communication method is a method chosen by the worker at the time of the work information submission.

27. The non-transient computer-readable media according to claim 25, further encoded such that the flexible communication method is a method chosen by the worker in advance of the work information submission.

28. The non-transient computer-readable media according to claim 25, further encoded such that the flexible communication method is determined in accordance with an escalation process starting with one communication method, and sequentially trying one or more communication methods, until an indication is received confirming receipt by the worker of the information.

29. The non-transient computer-readable media according to claim 25, further encoded such that the flexible communication method is via a group of SMS text messages when the work submission was received via a group of SMS text messages.

30. Non-transient computer-readable media, encoded to cause:
providing a mobile device including at least one processor, a display, and memory;
causing work information submissions to be sent from a service provider using the mobile device to an administrative agency for processing;
transmitting SMS messages from the mobile device;
determining if data service is active for the mobile device; and
presenting to the service provider on the display an SMS option graphical input user interface that allows the service provider to choose that a submission is to be sent as a set of SMS messages for processing.
